(19) United States
(12) Patent Application Publication
(10) Pub. No.: US 2010/0142478 A1
(43) Pub. Date: Jun. 10, 2010

(54) NEIGHBOR NETWORK ADVERTISEMENT

(75) Inventors: Mika Forssell, Soderkulla (FI); Janne Tervonen, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/530,047

(22) PCT Filed: Feb. 29, 2008
(86) PCT No.: PCT/IB2008/000461

§ 371 Date: Feb. 4, 2010

(30) Foreign Application Priority Data
Mar. 7, 2007 (US) 60905297

(51) Int. Cl. H04W 36/00

(52) U.S. Cl. 370/331

(57) ABSTRACT

A method and apparatus for enabling a network to provide information associated with neighboring network(s) of different access technologies to the wireless device, prior to the wireless device determining the need for a handover. When a determination is made by the network that a handover to a new access network is required, the network may send a message to the wireless device that commands the wireless device to leave a currently used access network. Alternatively, the network may send a message to the wireless device that guides or obligates the wireless device to select one of the access networks in the list, provided by the network, in case the wireless device chooses to make a handover. Upon receipt of a command message, the wireless device leaves a currently used access network either immediately or a reasonable time after having set up a connection to a new access network for ensuring smooth handover.

### REFERENCE TO RELATED APPLICATION

This application claims priority of U.S. Provisional Patent Application Ser. No. 60/905,297, filed on Mar. 7, 2007. The subject matter of the above referenced application is hereby incorporated by reference.

### BACKGROUND OF THE INVENTION

1. Field of the Invention

The present invention relates to a method and apparatus for providing network-guided handover for redirecting wireless devices in a heterogeneous access network environment, without creating additional complexity on affected devices.

2. Description of the Related Art

The Third Generation Partnership Project (3GPP) is in the process of standardizing the UMTS Terrestrial Radio Access Network (UTRAN), Long Term Evolution (LTE) and System Architecture Evolution (SAE). LTE focuses on enhancement of Universal Terrestrial Radio Access (UTRA) and optimization of the UTRAN architecture. Work on the SAE defines an evolved packet core network.

As more users join a “wireless society”, as more services are provided on the Internet, and as service requirements, such as multimedia bit rate increase, requirements for wireless capacity also increase. Since none of currently used access technologies have all of the necessary attributes, such as coverage and bit rate, in a single package, heterogeneity networks including different access technologies must be employed in access networks. As such, 3GPP and non-3GPP technologies will be implemented to complement each other. For example, in an access network, High Speed Packet Access (HSPA) technology may be used outdoors and Wireless Fidelity (Wi-Fi) may be used indoors to provide higher bit rates and to decrease use of expensive cellular networks. In a heterogeneous access environment, inter-working between provided access networks is crucial.

The handover methods used in 3GPP and IEEE WLAN (Wireless LAN) networks are generally classified as ‘hard’ or ‘soft’, depending on whether the handover procedure is “break before make” or “make before break” with respect to the data transport facilities that support the exchange of data packets between a mobile node and the network. In general, handover involves cooperative use of both the mobile node and network infrastructure in order to satisfy network operator and end user needs. For example, IEEE 802.21 standard defines a Media Independent Handover (MIH) functionality that allows for network-assisted and network-controlled wireless device mobility. Specifically, the wireless device includes a MIH functionality that communicates with the MIH functionality on the network. MIH functionality may be implemented using the access technology specific Layer 2 (L2) implementation or as a Layer 3 (L3) IP implementation that uses access technologies only as bit pipes transferring MIH messages.

This standard addresses 3GPP systems very loosely and considers only the L3 (IP-based) solution for deploying MIH mechanisms via a 3GPP network. The L3 solution might not provide the most efficient solution for deploying MIH mechanisms via 3GPP systems. Thus, additional signalling between the wireless device and the network might be required. The L3 solution also has an extra challenge, as an MIH server outside of the 3GPP network should be able to associate a wireless device's location with non-3GPP neighbors. Current wireless devices do not implement GPS technology by default and, thus, 3GPP system specific identifiers, like cell ID and routing area ID, have to be used. This requires a lot of configuration into a L3 MIH implementation as the information is currently unavailable beyond 3GPP systems at the moment.

Based on the current 802.21 standard, implementing a network based handover mechanism where the network redirects the wireless device from a 3GPP network to a specific non-3GPP network (like Wi-Fi) requires implementing additional complexities into network. For example, the services being executed, multi-radio capabilities, and the status of target network need to be known in order to perform successful handover. One current 3GPP specific implementation allows for a second generation (2G) cell to advertise to third generation (3G) neighbor cells and vice versa. Another 3GPP specific implementation redirects a wireless device to another defined cell. However, these current implementations do not redirect wireless devices in a heterogeneous access network environment between 3GPP and non-3GPP systems. Implementing handover mechanism according to currently known principles in 3GPP systems requires creating additional complexities on the affected devices that may not provide enough benefits when compared to gains.

### SUMMARY OF THE INVENTION

An embodiment of the invention is directed to a method and an apparatus for enabling a network to provide information associated with neighboring networks of the same or different access technologies to a wireless device. The information may be provided to the wireless device by the network, prior to the wireless device determining the need for a handover. The method includes sending, upon determination by the network that a handover to a new access network is required, a message to the wireless device that commands the wireless device to leave a currently used access network. The method also includes, upon receipt of the message, the wireless device selecting a new access network and leaving the currently used access network either immediately, a reasonable time after setting up a connection to the new access network, or after a delay condition is met. The message includes information associated with an access network list.

An embodiment of the invention is directed to a method including receiving, by the mobile node, at least one message from the network. The message is used to indicate to the mobile node that a handover to a new access network is required or to instruct the mobile node to select the new access network. The method also includes selecting, by the mobile node, the new access network and performing, by the mobile node, a handover from a currently used access network to the selected new access network.

Another embodiment of the invention is directed to an apparatus including a receiver configured to receive at least one message from the network. The message is used to indicate to the apparatus that a handover to a new access network is required or to instruct the apparatus to select the new access network. The apparatus also includes a selector configured to select the new access network and a performer configured to perform a handover from a currently used access network to the selected new access network.

Another embodiment of the invention is directed to an apparatus including receiving means for receiving at least one message from the network. The message is used to indicate to the apparatus that a handover to a new access network is required or to instruct the apparatus to select the new access network. The apparatus also includes selecting means for selecting the new access network and performing means for performing a handover from a currently used access network to the selected new access network.

Another embodiment is directed to an apparatus including a transmitter configured to transmit, to a mobile node, at least one message. The message is used to indicate to the mobile node that a handover to a new access network is required or to instruct the mobile node to select the new access network. The mobile node selects the new access network and performs a handover from a currently used access network to the selected new access network.

Another embodiment of the invention is directed to an apparatus including transmitting means for transmitting, to a mobile node, at least one message. The message is used to indicate to the mobile node that a handover to a new access network is required or to instruct the mobile node to select the new access network. The mobile node selects the new access network and performs a handover from a currently used access network to the selected new access network.

Another embodiment of the invention is directed to a method including transmitting at least one message to a mobile node, the message being used to indicate to the mobile node that a handover to a new access network is required or to instruct the mobile node to select the new access network. The mobile node selects the new access network and performs a handover from a currently used access network to the selected new access network.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates how a Media Independent Handover (MIH)-enabled mobile node may communicate with a MIH-enabled network in an embodiment of the invention;

FIG. 2 illustrates an embodiment of a mobility management protocol stack of the mobile node or the network entity;

FIG. 3 illustrates a current definition of MIH_Switch Request message implemented in an embodiment of the invention;

FIG. 4 illustrates how the handover mode field is further defined;

FIG. 5 illustrates an example of how information elements could be added into the message, if using MIH_Switch Request message to initiate handover procedure;

FIG. 6 illustrates the possible contents of the access network list type field implemented in an embodiment of the invention;

FIG. 7 illustrates an example of a definition for access network list field implemented in an embodiment of the invention;

FIG. 8 illustrates the steps implemented in an embodiment of the present invention; and

FIG. 9 illustrates an embodiment of a mobile node which implements an embodiment of the invention.

### DETAILED DESCRIPTION OF PREFERRED EMBODIMENTS

Reference will now be made to the preferred embodiments of the present invention, examples of which are illustrated in the accompanying drawings. The present invention relates to defining a method and apparatus for providing network-guided handover for redirecting wireless devices in a heterogeneous access network environment, without creating unnecessary complexity on affected devices.

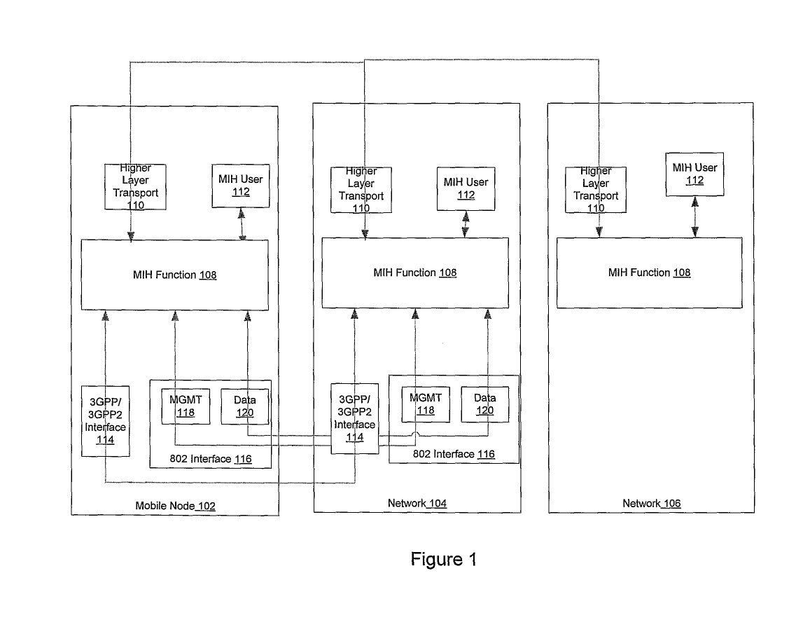

FIG. 1 illustrates how a Media Independent Handover (MIH)-enabled mobile node 102 may communicate with a MIH-enabled network 104. When connected to a network, for example an 802 network, mobile node 102 may directly use Layer (L2) or Layer 3 (L3) for exchanging MIH signalling. Mobile node 102 may be able use L2 for exchanging MIH signalling for certain 802 networks, even before being authenticated with the network. When connected to a 3GPP/3GPP2 network 106, mobile node 102 may use L2 or L3 transport to conduct MIH signalling. Each of mobile node 102 and network 104 and 106 includes a MIH Function 108, a higher layer transport entity 110 and MIH users 112. Mobile node 102 and network 104 may also include for example a 3GPP/3GPP2 and/or WiMAX Interface 114. In an embodiment of the invention, interface 114 may also be a WLAN interface, a WI-FI interface and/or a Ultra Wideband interface. Mobile node 102 and network 104 also include an 802 Interface 116 with management function 118 and data 120. The present invention may be utilized in any access network, for example IEEE 802.21 network, WLAN, 3GPP or WiMAX.

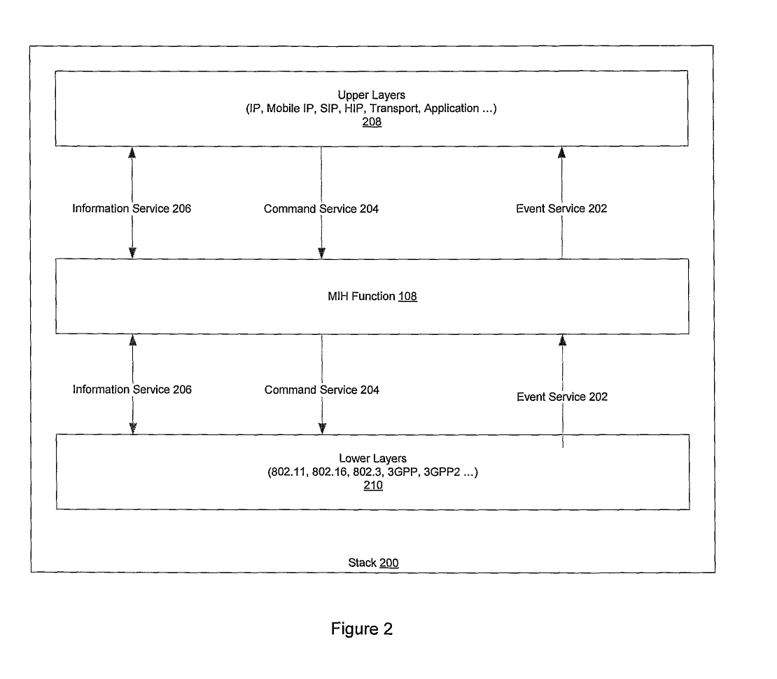

FIG. 2 illustrates the placement of a MIH Function 108 within a mobility management protocol stack 200 of mobile node 102 or network entity 104. The stack includes an upper layer 208, a MIH function 108 and a lower layer 210. MIH function 108 provides services to MIH users 112 through a single technology independent interface and obtains services from lower layers through a variety of technology dependent interfaces. The primary role of MIH function 108 is to facilitate handovers and provide intelligence to a network selector entity or the mobility management entity responsible for handover decision. MIH function 108 aids the network selector entity with the help of Event Service 202, Command Service 204, and Information Service 206.

Handovers may occur either between two different access networks or between two different points of attachment of a single access network. Network discovery is essential to provide new possibilities for network selection to suit the need of the applications and mobility. Current standards define the network information and specify the means by which such information may be obtained for supported access networks and made available to MIH Users 112. The network information could include information about link type, link identifier, link availability and link quality.

An embodiment of the present invention provides a MIH based network-guided handover procedure that provides a method for informing a wireless device to stop using a current network. The MIH based network-guided handover method also defines candidate target networks for the wireless device and allows the wireless device to select a new target network based on provided information and network selection policies that may be local to the wireless device or assigned by network. This allows network load sharing without creating unnecessary complexity on the access network. For example, when a HSPA cell becomes congested by multiple wireless devices transferring multimedia, an embodiment of the present invention allows some wireless devices to be moved a neighbor WiMAX/Wi-Fi cell, without increasing the complexity of the overall access network.

A network or a wireless device, for example network 104 or mobile node 102, detects the need to make a handover to a new access network. As noted above, the new access network may implement a different access technology. For example, there may be a handover from 3GPP to Wi-Fi, or the new access network may be a different point of attachment of the same access technology, for example, a handover where SSid=NET1 to SSid=NET2. The handover need is determined based on several factors, including network load, Quality of Service (QoS), radio link quality, the preferred access network and/or the multi-radio capability of wireless device, that is, the supported access technologies of the wireless device. In the case where the wireless device detects the need to select a new access network, the wireless device may notify the network to trigger the handover procedure.

In an embodiment of the invention, the network may provide information associated with neighboring network(s) of same or different access technologies to the wireless device, prior to the wireless device determining the need for a handover. This prepares the wireless device for handover and provides a controlled list of potential new target networks to wireless device. Either the network or the wireless device may initiate this procedure in order to provide control over the wireless device's mobility, without pre-defining exactly which access network should be selected, but leaving that decision for later determination by the wireless device. The present invention, therefore, eliminates the requirement of having the wireless device in an access network, by defining candidate access networks and commanding the wireless device to move to one of the candidate access networks. In an embodiment of the invention, the wireless device does not determine a “need for handover”, the wireless device is told to move a new access network; however, the wireless device determines the next target network.

When a determination is made by the network that a handover to a new access network is required, in an embodiment of the invention, the network may send a message to the wireless device that commands the wireless device to leave a currently used access network or a currently used point of attachment in the current access network. However, the network may leave the selection of the new access network or new point of attachment to the wireless device. Alternatively, the network may send a message to the wireless device that guides or obligates the wireless device to select one of the access networks in a list provided by the network. Alternatively, the network may send a message to the wireless device that guides or obligates the wireless device not to select one of the access networks in a list provided by the network.

The list of access networks provided by the network to the wireless device may be prioritized by the network. The candidate access network list may be provided to the mobile node in the command message. Upon receiving the list, the wireless device starts preparing for handover to one of the candidate access networks. Upon receipt of a command message, the wireless device leaves a currently used access network either immediately or a reasonable time after setting up a connection to a new access network, for ensuring smooth handover. Alternatively, the network may indicate a delay to the wireless device that defines a condition which indicates how long the wireless device is allowed to use current access network before leaving the access network. An example of the condition may be time or receipt of a signal.

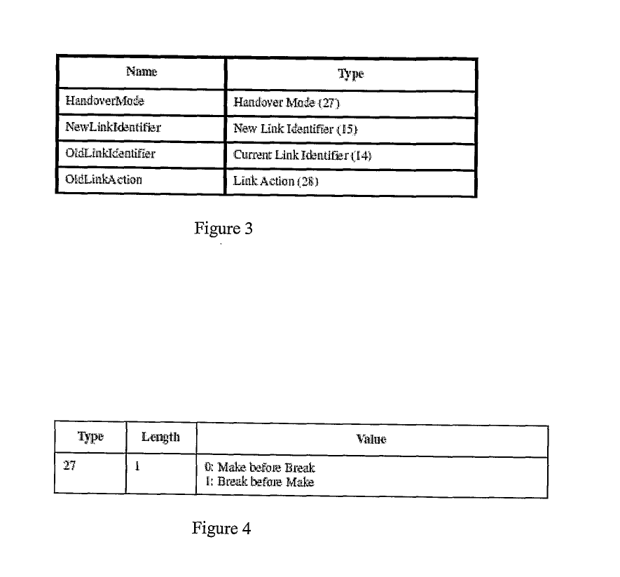

The command message may include information such as, which method is to be used to allow the network to quickly reduce the load in an access network. For example, in 802.21 standards, a MIH_Switch message may be used to command the wireless device to perform a handover. FIG. 3 illustrates a current definition of MIH_Switch Request message. MIH_Switch includes a handover mode field, a new link identifier field, an old link identifier field and an old link action field. The handover mode field may be used to indicate the handover mode that is used. For example, handover mode field may be used to indicate how the wireless device is to implement a handover procedure. The new link identifier and old link identifier fields provide identifiers for a new and old link respectively. The old link action field specifies the suggested action on a link during handover.

Upon receipt of the MIH_Switch command, the wireless device checks the handover mode field first. If the handover mode field is defined as a “make before break”, the wireless device tries to execute a Link Connect command to establish the new link before the old link is gone. If the handover mode field is defined as “break before make”, the wireless device tries to disable the old link before the new link is established. Depending on the old link actions field, the wireless device may select the ways to disable the old link. A corresponding indication (MIH_Switch.indication) may be triggered to send to all subscribed MIH user entities in the local stack.

FIG. 4 illustrates how the handover mode field is further defined according to the 802.21 standards. Specifically, FIG. 4 illustrates that the handover mode field is defined as either “Make before Break” or “Break before Make”. In the same way, delay condition information for performing handover may be assigned to a wireless device.

When the access network provides a prioritized access network list to the wireless device, the list is created as either a predefined list of access networks in a given order or the order of the access networks in the list may depend on several factors. For example, the order of the access networks in the list may depend on the load and capacity of a target network (if available), active services and/or QoS requirements, the wireless device multi-radio capabilities, and the radio link quality of the target network. As is known to those skilled in the art, there might be limitations of having some radio combination active at the same time, so the wireless device multi-radio capabilities may be one of the criteria in determining the order of the access networks in the list. If a prioritized access network list is provided to the wireless device, the wireless device may be obligated to select the highest priority access network meeting other requirements. For example, if a first Wi-Fi network has the highest priority in the list but does not have the required signal strength or available bandwidth to support video streaming, the wireless device may select a second priority Wi-Fi access network that has a lower priority but also has the required signal strength and bandwidth. If a non-prioritized access network list is provided to the wireless device, the wireless device may be obligated to select one of the defined access networks and leave the current access network. If a non-preferred access network list is provided to the wireless device, the wireless device may be obligated not to select one of the defined access networks and the wireless device may leave the current access network. Preferred and non-preferred access network list information may be included into a single message guiding wireless device handover operation and selection of new access network.

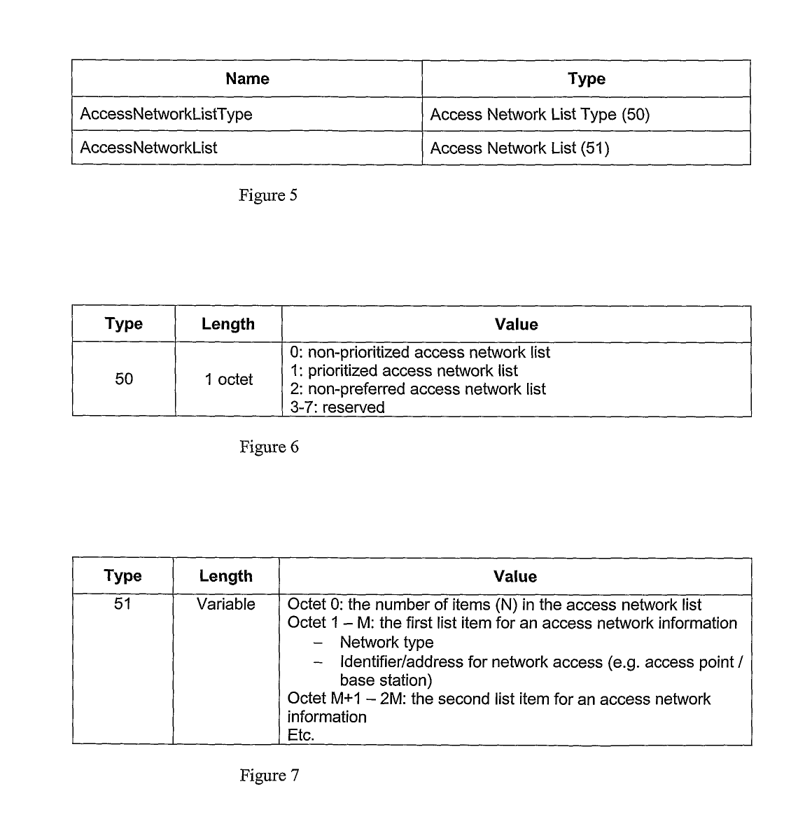

New information elements may be introduced into current 802.21 command message to define whether the access network list is prioritized or informative, as well as, to define the access network list itself. FIG. 5 illustrates an example of information elements that could be added into the message, if using MIH_Switch Request message to initiate handover procedure. Specifically, an access network list type field and an access network list field could be added to the MIH_Switch Request field illustrated in FIG. 3. Optionally, there may be multiple instances of access network lists, one for each distinct access network list types. The access network list of FIG. 5 may be used instead of or in addition to the currently existing new link identifier parameter of FIG. 3.

FIG. 6 illustrates the possible contents of the access network list type field. The access network list type field may be defined as a “non-prioritized access network list”, a “prioritized access network list or “non-preferred access network list”. The access network list field may include various kind of information. FIG. 7 illustrates an example of a definition for access network list field. The network or access technology type and an identifier/address of the possible access network (e.g. access point or base station) may be required. However, the access network list field may also include other useful information such as, parameters describing the QoS parameter and/or services that the access point/base station is capable of supporting either theoretically or at current moment of time. The access network list field may be defined to include the number of items in the access network list, and each item for access network information may be defined to include the network type and identifier for network access. Therefore, the present invention provides for improved mobility and service continuity and it enables the use of media independent handover and decreases unnecessary network complexity.

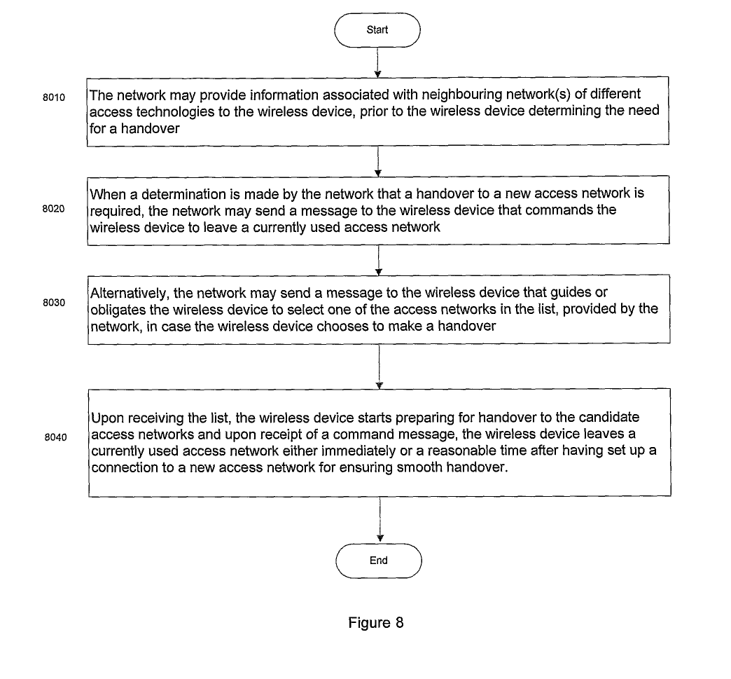

FIG. 8 illustrates the steps implemented in an embodiment of the present invention. In Step 8010, the network may provide information associated with neighboring network(s) of different or same access technologies to the wireless device. The information may be provided prior to the wireless device determining the need for a handover. In Step 8020, when a determination is made by the network that a handover to a new access network is required, the network may send a message to the wireless device that commands the wireless device to leave a currently used access network. The determination may be made locally by the network or the wireless device may send a message to the network that handover is required. In Step 8030, alternatively, the network may send a message to the wireless device that guides or obligates the wireless device to select one of the access networks in the list, provided by the network, in case the wireless device chooses to make a handover. The neighbor network information that the wireless device uses when making handover may be received in the handover command message or in a separate message that is sent to the wireless device before or after the actual handover command. If the neighbor network information is sent after the handover command message, a delay condition in the message may be used to inform the wireless device to wait for additional message(s). This allows, for example, using L3 MIH messages for delivering information to a wireless device and then reusing 3GPP handover command message without defining candidate target networks. Thus, the messages sent in steps 8020 and 8030 may be separate messages or the same message. As noted above, the network may provide information associated with neighboring network(s) of different access technologies to the wireless device.

In Step 8040, upon receiving the list, the wireless device starts preparing for handover to the candidate access network and upon receipt of a command message, the wireless device leaves a currently used access network either immediately or a reasonable time after setting up a connection to a new access network. A list of preferred/banned access networks may also be provided in a separate message sent to a wireless device before or after the actual handover command message. If sent after, the handover command message or standard shall contain delay condition informing wireless device to wait for additional message.

Alternatively, the network may send a message to the wireless device. The message command the wireless device to leave current access network but the message leaves the selection of new access network to the wireless device. The message may or may not include a delay condition for indicating when the wireless device may leave currently used access network.

It should be noted that other methods may be used to implement embodiments of the present invention. For example, instead of using MIH messages for handover, access technology internal messages may also be used. For example, a 3GPP GPRS Packet Cell Change Order message may be used to redirect the wireless device from a GPRS/EDGE system to another access network. Thus, the Packet Cell Change Order message might include a preferred/non-preferred access network list and delay information for the wireless device to consider. Alternatively, the MIH function may be integrated into access technology, like 3GPP, Wi-Fi, WiMAX, or it may be located outside access technologies. The combination of integrating the MIH function into the access technology and locating it outside of the access technologies is also possible.

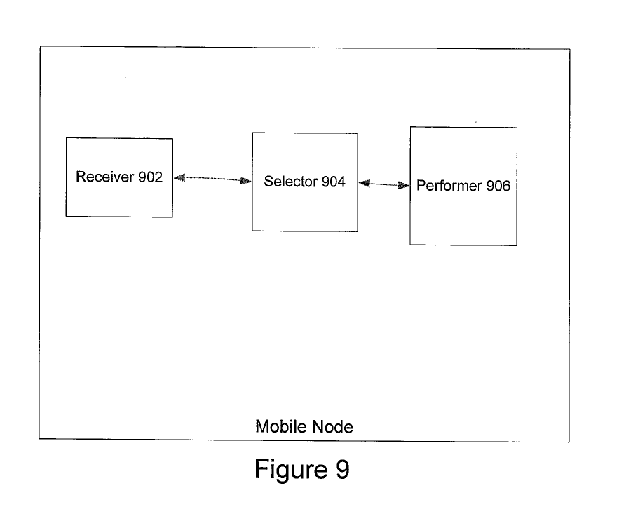

FIG. 9 illustrates an embodiment of the mobile node which implements the present invention. The mobile node includes a receiver 902 configured to receive at least one message from a network. The message is used to indicate to the mobile node that a handover to a new access network is required or to instruct the mobile node to select the new access network from an access network list received from the network. The mobile node also includes a selector 904 configured to select the new access network based on information associated with the received access network list. The mobile node further includes a performer 906 configured to perform a handover from a currently used access network to the selected new access network.

It should be appreciated by one skilled in art, that the present invention may be utilized in any wireless device or network that utilizes access network technologies. The foregoing description has been directed to specific embodiments of this invention. It will be apparent, however, that other variations and modifications may be made to the described embodiments, with the attainment of some or all of their advantages. Therefore, it is the object of the present invention to cover all such variations and modifications as come within the true spirit and scope of the invention.

1-71. (canceled)

72. A method, comprising:
receiving, by a mobile node, at least one message and an access network list from a network, the message being used to indicate to the mobile node that a handover to a new access network is required or to instruct the mobile node to select the new access network;
selecting, by the mobile node, the new access network based at least in part on information associated with the network access list; and
performing, by the mobile node, a handover from a currently used access network to the selected new access network.

73. The method of claim 72, wherein the access network list comprises a prioritized list of access networks, wherein the mobile node performs a handover to a highest priority access network that fulfils predefined criteria.

74. The method of claim 72, wherein the access network list is received after receipt of the message, wherein the message includes a delay condition for informing the mobile node to wait for a second message with the access network list.

75. The method of claim 72, wherein the message is a layer two message for handover signalling or the message is carried in layer three transportation.

76. The method of claim 72, wherein the message includes at least one of a network type, an identifier for the network, and a link action list.

77. An apparatus, comprising:
a receiver configured to receive at least one message and an access network list from a network, the message being used to indicate to the apparatus that a handover to a new access network is required or to instruct the apparatus to select the new access network;
a selector configured to select the new access network based at least in part on information associated with the network access list; and
a performer configured to perform a handover from a currently used access network to the selected new access network.

78. The apparatus of claim 77, wherein the access network list includes information associated with services that the new access network is capable of supporting.

79. The apparatus of claim 77, wherein the message includes at least one of a network type, an identifier for the network and a link action list.

80. The apparatus of claim 77, wherein there are multiple instances of the access network list, each instance being for a distinct access network list type.

81. The apparatus of claim 77, wherein the access network list comprises a prioritized list of access networks and wherein the apparatus performs a handover to a highest priority access network that fulfils predefined criteria.

82. The apparatus of claim 77, wherein the performer is configured to perform the handover after connection to the new access network is established.

83. The apparatus of claim 77, wherein the receiver is configured to receive the access network list after receipt of the message, wherein the message includes a delay condition for informing the apparatus to wait for the a message with the access network list.

84. An apparatus, comprising:
a transmitter configured to transmit, at least one message and an access network list to a mobile node, the message being used to indicate to the mobile node that a handover to a new access network is required or to instruct the mobile node to select the new access network based at least in part on information associated with the received access network list and to enable the mobile node to perform a handover from a currently used access network to the selected new access network.

85. The apparatus of claim 84, wherein the transmitter is configured to transmit the message prior to or after detection by the mobile node of a need to make a handover to the new access network.

86. The apparatus of claim 84, wherein the access network list comprises an access network list type and other information associated with the access network list.

87. The apparatus of claim 84, wherein the transmitter is configured to transmit the access network list after receipt of the message, wherein the message includes a delay condition for informing the mobile node to wait for the a second message with the access network list.

88. The apparatus of claim 84, wherein the message is a layer two message for handover signalling or the message is transmitted in layer three transportation.

89. The apparatus of claim 84, wherein the access network list includes information associated with services that the new access network is capable of supporting.

90. The apparatus of claim 84, wherein the message includes at least one of a network type, an identifier for the network and a link action list.

91. A method, comprising:
transmitting at least one message and an access network list to a mobile node, the message being used to indicate to the mobile node that a handover to a new access network is required or to instruct the mobile node to select the new access network based at least in part on information associated with the received access network list, and to enable the mobile node to perform a handover from a currently used access network to the selected new access network.

92. The method of claim 91, wherein the transmitting comprises transmitting the access network list after receipt of the message, wherein the message includes a delay condition for informing the mobile node to wait for the a second message with the access network list.

93. The method of claim 91, wherein the message includes at least one of a network type, an identifier for the network and a link action list.

94. The method of claim 91, wherein there are multiple instances of the access network list, each instance being for a distinct access network list type.
